(19) United States
(12) Patent Application Publication
(10) Pub. No.: US 2005/0271070 A1
(43) Pub. Date: Dec. 8, 2005

(54) Radio module

(75) Inventors: Taro Mikami, Osaka (JP); Takeshi Yoshida, Osaka (JP); Suguru Ogawa, Osaka (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD.

(21) Appl. No.: 11/133,330

(22) Filed: May 20, 2005

(30) Foreign Application Priority Data
May 20, 2004 (JP) P.2004-150184

(51) Int. Cl. H04B 7/00

(52) U.S. Cl. 370/412; 370/310

(57) ABSTRACT

The objective of the invention is the constant optimization of the sizes of buffers required for a transmission process and a reception process, and the effective use of memory resources. A contents processor includes a contents change detector. When the contents are changed, the contents change detector transmits to a wireless communication unit a contents identifier corresponding to contents that are to be newly processed by the wireless communication unit. The wireless communication unit includes a contents information table in which information concerning the contents is stored. The wireless communication unit examines the contents information table, obtains the sizes of buffers required for a transmission process and a reception process, based on the contents identifier transmitted by the contents processor, and redistributes the transmission buffer and the reception buffer for a buffer queue.

### BACKGROUND OF THE INVENTION

1. Field of the Invention

The present invention relates to optimal control provided for a transmission buffer and a reception buffer during wireless data communication.

2. Description of the Related Art

A market, centered around PCs, has been developed for wireless communication systems, and the use of wireless communication systems has spread. Wireless communication systems can be constituted by employing the abundant memory resources available of a PC, without much having to take into account limitations imposed by the sizes of memories used for wireless communication.

However, a wireless communication function has also begun to be mounted in electric household appliance, such as AV apparatuses, to perform video transmission, and high quality wireless transmission is also required in environments wherein abundant memory resources, like those provided by PCs, are not available. Therefore, optimal control of buffer sizes is demanded.

According to a conventional buffer control method for wireless communication, a transmission buffer and a reception buffer are regarded as a single unit, with a boundary established between the buffers, and when either buffer is full while space is still available in the other, the boundary is moved so that the vacant space can be used (see, for example, U.S. Pat. No. 6,094,695).

However, this conventional control method is the best effort control method, and when deviation of the frequency of the performance occurs, to either a transmission process or a reception process, a buffer can be used for only one of the processes.

This problem will be explained while referring to the drawings. FIG. 1 is a diagram showing a wireless network configuration comprising two wireless communication units 100B and 100C and two contents processors 100A and 100D, which employ the wireless communication units 100B and 100C to transmit various contents types, such as video data.

A function is provided for the contents processor 100A for processing various contents types, such as MPEG data, and a function is provided for the wireless communication unit 100B for performing a transmission process for transferring, during a wireless transmission interval, contents received from the contents processor 100A, via the wireless communication unit 100C, to the contents processor 100D.

Similarly, a function is provided for the contents processor 100D for processing various contents types, such as MPEG data, and a function is provided for the wireless communication unit 100C for performing a transmission process, within a wireless section, for transferring contents received from the contents processor 100D, via the wireless communication unit 100B, to the contents processor 100A.

In the thus constructed wireless network, when, for example, the contents processor 100A employs the band of the wireless section to transmit, at the maximum, the contents to the contents processor 100D, the transmission process in the wireless section occurs in the wireless communication unit 100B, and a transmission buffer 110 is employed, while the reception process in the wireless section occurs in the wireless communication unit 100C, and a reception buffer 120 is employed.

At this time, as is shown in FIG. 2, a reception buffer 120 is not used in the wireless communication unit 100B on the transmission side, while a transmission buffer 110 is not employed in the wireless communication unit 100C on the reception side, so that the buffers of the wireless communication units 100B and 100C are not used effectively.

### SUMMARY OF THE INVENTION

The objective of the present invention is to provide a radio module that always optimizes the sizes of buffers required for a transmission process and a reception process, so that memory resources can be employed effectively.

A radio module according to this invention comprises:

a wireless communication unit for performing the wireless communication of contents; and

a contents processor for processing contents that are to be transmitted or that are received by the wireless communication unit,

wherein the wireless communication unit includes
a buffer queue having a variable buffer structure whereby provided are a transmission buffer area, for temporarily holding the contents to be transmitted, and a reception buffer area, for temporarily holding the received contents, and

wherein, in accordance with the type of contents processed by the contents processor, the transmission buffer area and the reception buffer area for the buffer queue are changed.

According to this arrangement, since the transmission buffer area and the reception buffer area for the buffer queue can be changed in accordance with the type of contents, the sizes of the buffers required for the transmission process and the reception process can always be optimized, and the memory resources can be utilized effectively.

For the radio module of the invention, the wireless communication unit further includes:

a contents information table in which information concerning the size of a buffer required for a process, and information indicating the type of process, either a transmission process or a reception process, are to be stored in correlation with the contents type. When the contents type to be processed is changed to a different type, the contents processor transmits to the wireless communication unit information concerning the different contents type, and the wireless communication unit examines the contents information table to change the transmission buffer area and the reception buffer area for the buffer queue.

According to this arrangement, when the contents type to be processed by the contents processor is changed, the wireless communication unit examines the contents information table to change the transmission buffer area and the reception buffer area for the buffer queue. Therefore, the sizes of the buffers required for the transmission process and the reception process can always be optimized, and the memory resources can be employed effectively.

For the radio module of the invention, information concerning the size of a buffer required for a process includes an average rate required for the transmission/reception of the contents, and in accordance with the average rate, the wireless communication unit changes the transmission buffer area and the reception buffer area for the buffer queue.

According to this arrangement, since the wireless communication unit, in accordance with the average rate, changes the transmission buffer area and the reception buffer area for the buffer queue, the sizes of the buffers required for the transmission process and the reception process can always be optimized, and the memory resources can be utilized effectively.

For the radio module of the invention, information concerning the size of a buffer required for a process includes a recommended buffer size to be allocated for the contents, and in accordance with the recommended sizes of buffers, the wireless communication unit changes the transmission buffer area and the reception buffer area for the buffer queue.

According to this arrangement, since the wireless communication unit, in accordance with the recommended sizes of buffers, changes the transmission buffer area and the reception buffer area for the buffer queue, the sizes of the buffers required for the transmission process and the reception process can always be optimized, and the memory resources can be employed effectively.

For the radio module of this invention, the buffer queue includes:

a transmission buffer queue, used for transmission;

a reception buffer queue, used for reception; and

a spare buffer queue, from which the size of a buffer can be allocated for the transmission buffer queue and the reception buffer queue.

According to this structure, the transmission process and the reception process need not be halted for the rearrangement of buffers. Further, the exclusive process need not be performed to prevent contention for the use of a buffer, and the buffer areas can be changed efficiently.

For the radio module of the invention, information concerning the size of a buffer required for a process includes a use history, for the size of a buffer used for the contents in the past, and in accordance with the use history, the wireless communication unit changes the transmission buffer area and the reception buffer area for the buffer queue.

According to this arrangement, since in accordance with the use history the wireless communication unit changes the transmission buffer area and the reception buffer area for the buffer queue, the sizes of buffers required for the transmission process and the reception process can always be optimized, and the memory resources can be employed effectively.

For the radio module of the invention, the use history is the maximum value for the size of a buffer used for the contents in the past.

According to this structure, since the wireless communication unit changes the transmission buffer area and the reception buffer area for the buffer queue, in accordance with the maximum value for the size of a buffer used for the contents in the past, the sizes of the buffers required for the transmission process and the reception process can always be optimized, and the memory resources can be utilized effectively.

For the radio module of the invention, information concerning the size of a buffer required for a process includes an error rate for each contents type and a corrected size for a buffer corresponding to the error rate. The wireless communication unit calculates the error rate during the transmission and reception of the contents, and in accordance with a corrected size for a buffer, changes the transmission buffer area and the reception buffer area for the buffer queue.

According to this arrangement, since the wireless communication unit changes the transmission buffer area and the reception buffer area for the buffer queue, in accordance with the error rate for each of the contents and the corresponding corrected size of a buffer, the amount of a buffer required for the transmission process and the reception process can be always optimized, and the memory resources can be effectively employed.

For the radio module of the invention, information concerning the size of a buffer required for a process includes an error rate for each contents type and a recommended size for a buffer corresponding to the error rate. The wireless communication unit calculates the error rate during the transmission and reception of the contents, and in accordance with the recommended size for a buffer, changes the transmission buffer area and the reception buffer area for the buffer queue.

According to this arrangement, since the wireless communication unit changes the transmission buffer area and the reception buffer area for the buffer queue in accordance with the error rate for the contents and the corresponding recommended size for a buffer, the sizes of the buffers required for the transmission process and the reception process can always be optimized, and the memory resources can be utilized effectively.

For the radio module of the invention, information concerning the size of a buffer required for a process includes priority information for each contents type, and in accordance with the priority information, the wireless communication unit changes the transmission buffer area and the reception buffer area for the buffer queue.

According to this arrangement, since in accordance with the priority information, the wireless communication unit changes the transmission buffer area and the reception buffer area for the buffer queue, the sizes of the buffer required for the transmission process and the reception process can always be optimized, and the memory resources can be employed effectively.

For the radio module of the invention, the wireless communication unit has a function for updating, adding or deleting information stored in the contents information table.

This arrangement can easily cope with an increase in the contents types that a user can select, or the addition or changing of a contents processor, such as an AV apparatus, that is to be connected to a wireless communication unit that serves as a transmission source.

According to the invention, since the transmission buffer area and the reception buffer area for the buffer queue are changed in accordance with the contents type, the sizes of the buffers required for the transmission process and the reception process can always be optimized, and the memory resources can be utilized effectively.

Furthermore, since the wireless communication unit constantly obtains the sizes of the buffers required for the transmission process and the reception process, it is possible to prevent the occurrence of a phenomenon whereby, although the size of the reception buffer is adequate, the size of the transmission buffer is reduced, thereby hindering the performance of a required transmission process, and also of a phenomenon whereby, although the size of the transmission buffer is adequate, the size of the reception buffer is reduced, and the performance of a required reception process is hindered.

### BRIEF DESCRIPTION OF THE DRAWINGS

FIG. 1 is a schematic diagram for explaining the configuration of a conventional wireless network.

FIG. 2 is a diagram for explaining the use state of the transmission buffer and the reception buffer of a conventional wireless communication unit.

FIG. 3 is a schematic block diagram showing the configuration of a radio module according to a first embodiment of the invention.

FIG. 4 is a diagram for explaining a contents information table stored in a wireless communication unit according to the first embodiment.

FIG. 5 is a flowchart for explaining the buffer rearrangement processing for the first embodiment.

FIG. 6 is a diagram showing an example distribution for a transmission buffer and a reception buffer in a buffer queue according to the first embodiment.

FIG. 7 is a diagram showing an example distribution for a spare buffer queue, a transmission buffer queue and a reception buffer queue.

FIG. 8 is a diagram for explaining a contents information table including history information according to a second embodiment of the invention.

FIG. 9 is a flowchart showing the history information setting processing according to the second embodiment.

FIG. 10 is a diagram for explaining a contents information table including an error correction value according to a third embodiment of the invention.

FIG. 11 is a flowchart showing the buffer rearrangement processing using an error rate according to the third embodiment.

FIG. 12 is a diagram showing a contents information table including the allocated size of a buffer consonant with an error rate according to the third embodiment.

FIG. 13 is a diagram for explaining a contents information table including priority information according to a fourth embodiment of the invention.

FIG. 14 is a diagram showing an example updating of a contents information table according to a fifth embodiment of the invention.

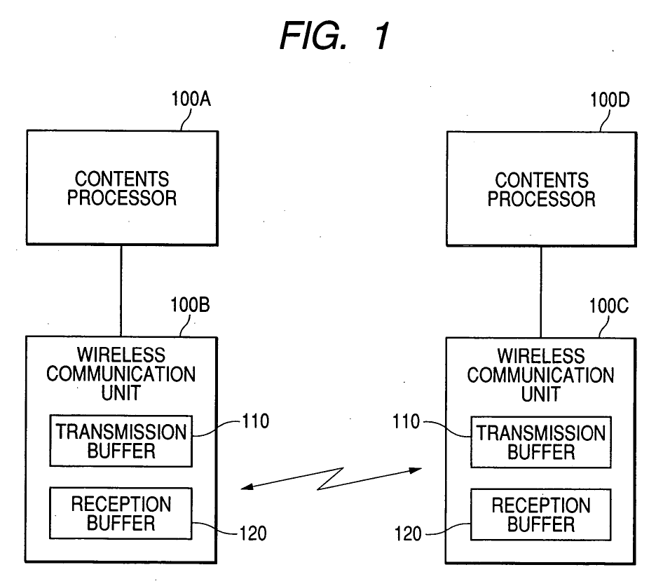

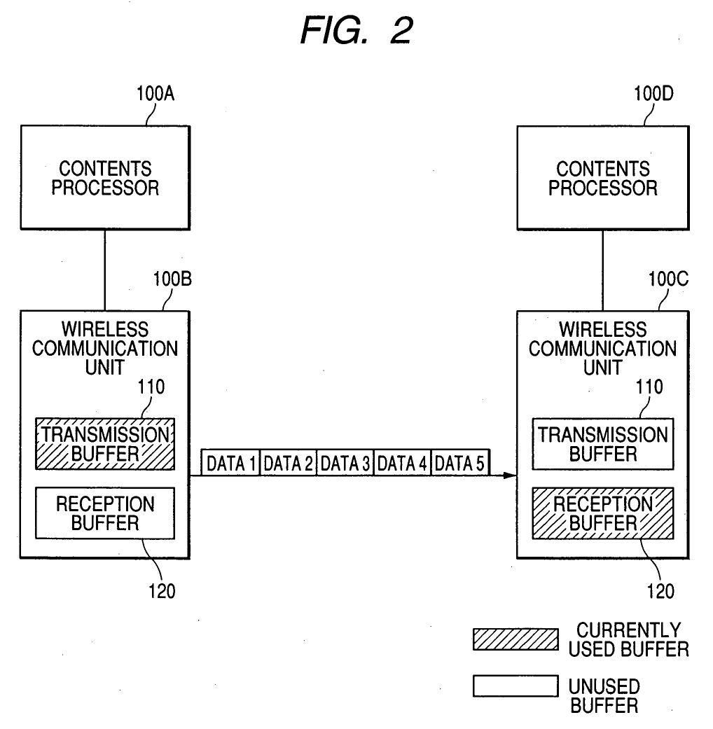

### DESCRIPTION OF THE PREFERRED EMBODIMENTS

### First Embodiment

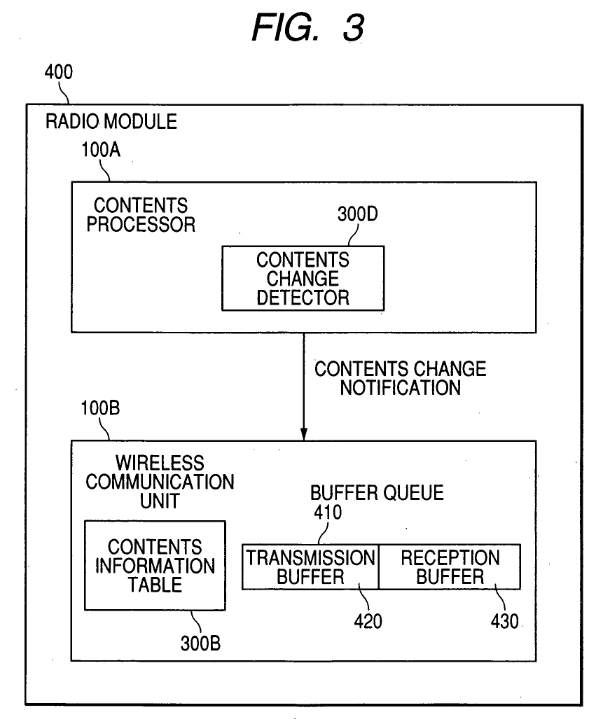

FIG. 3 is a schematic block diagram showing the configuration of a radio module 400 according to a first embodiment of the present invention. The radio module 400 for this embodiment comprises: a wireless communication unit 100B, for performing wireless communication for the contents; and a contents processor 100A, for processing the contents that are to be transmitted or that are received by the radio communication unit 100B.

Included in the contents processor 100A is a contents change detector 300D. When the contents are changed, the contents change detector 300D transmits to the wireless communication unit 100B a contents identifier corresponding to the contents that are newly to be processed by the wireless communication unit 100B.

The wireless communication unit 100B includes a contents information table 300B, in which information concerning the contents is stored. The wireless communication unit 100B examines the contents information table 300B, and based on the contents identifier transmitted by the contents processor 100A, obtains the sizes of buffers required for the transmission process and the reception process, and again distributes a transmission buffer 420 and a reception buffer 430 in a buffer queue 410.

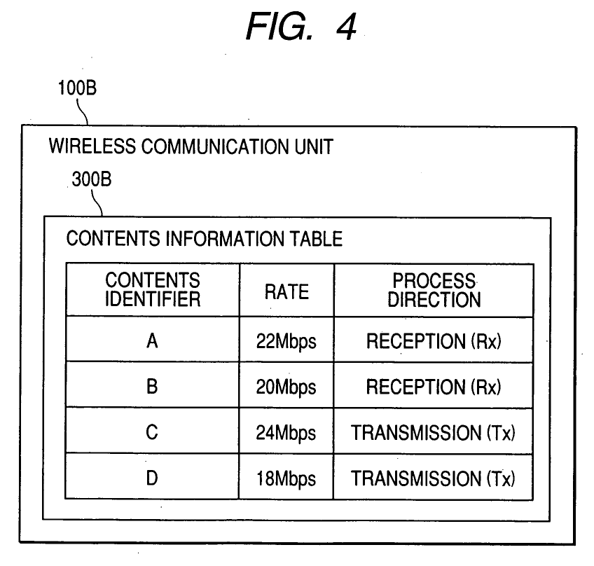

FIG. 4 is a diagram for explaining the contents information table 300B of the wireless communication unit 100b. The contents information table 300B, wherein the contents information is entered, is held in the memory area inside the wireless communication unit 100B, and is prepared in advance before wireless communication is initiated.

As is shown in FIG. 4, average rates for the contents distributed by individual broadcast stations and process direction information, indicating either a transmission or a reception, are stored in the contents information table 300B in correlation, for example, with contents identifiers A, B, C and D.

Since the contents information table 300B is stored in the memory of the wireless communication unit 100B, the wireless communication unit 100B examines the contents information table 300B, as needed, and employs the average rate to calculate the size of a buffer required for each contents type entered in the contents information table 300B. Thus, the wireless communication unit 100B can determine the distribution of the buffers required for the contents, and can rearrange the buffers.

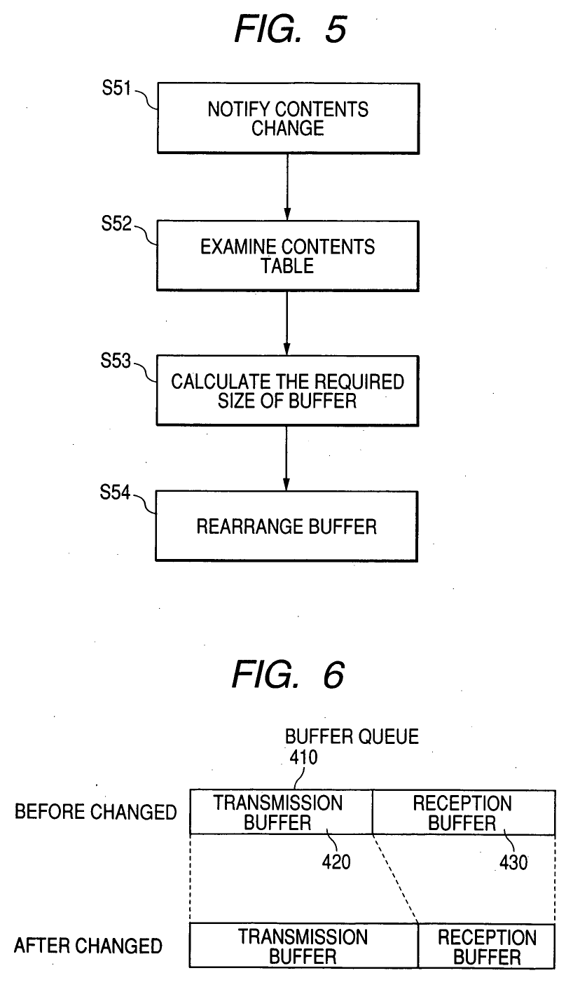

FIG. 5 is a flowchart showing the processing for rearranging the buffers when the contents are changed. When a user changes a current channel, or selects a source having a different average rate, i.e., selects different contents, the contents processor 100A transmits a contents change notification to the wireless communication unit 100B (step S51).

Upon receiving the contents change notification, the wireless communication unit 100B employs the contents identifier included in this notification to search the contents information table 300B wherein values have been entered in advance (step S52). When an entry that matches the contents identifier is found, the wireless communication unit 100B reads the corresponding average rate and the direction information indicating the performance of a the transmission or of a reception.

Assume that the contents information table 300B in FIG. 4 is stored in the wireless communication unit 100B. When a host transmits to the wireless communication unit 100B a notification that the current contents have been changed to the contents C, the wireless communication unit 100B reads, from the contents information table 300B, the entry, average rate=24 Mbps, for the contents C and the direction information Tx (transmission).

The required size of a buffer can be calculated based on the average rate obtained. That is, when the average rate is high, the size required for the buffer is increased, and when the average rate is low, the size required for the buffer is reduced.

Therefore, the size required for the buffer is calculated based on the average rate obtained (step S53), and the buffers are rearranged as shown in FIG. 6 (step S54). In FIG. 6 is shown a case wherein the size of the buffer predesignated for the transmission is increased because the contents are changed. As the buffer arrangement in this example, the size of the reception buffer 430 for the buffer queue 410 is reduced, and the size of the transmission buffer 420 is increased.

Conventionally, since the transmission buffer 420 and the reception buffer 430 are provided in a single buffer queue, the transmission process and the reception process must be halted each time the buffers are rearranged, and since an exclusive process must be performed to prevent contention for the use of buffers, the rearrangement of the buffers can not efficiently be performed.

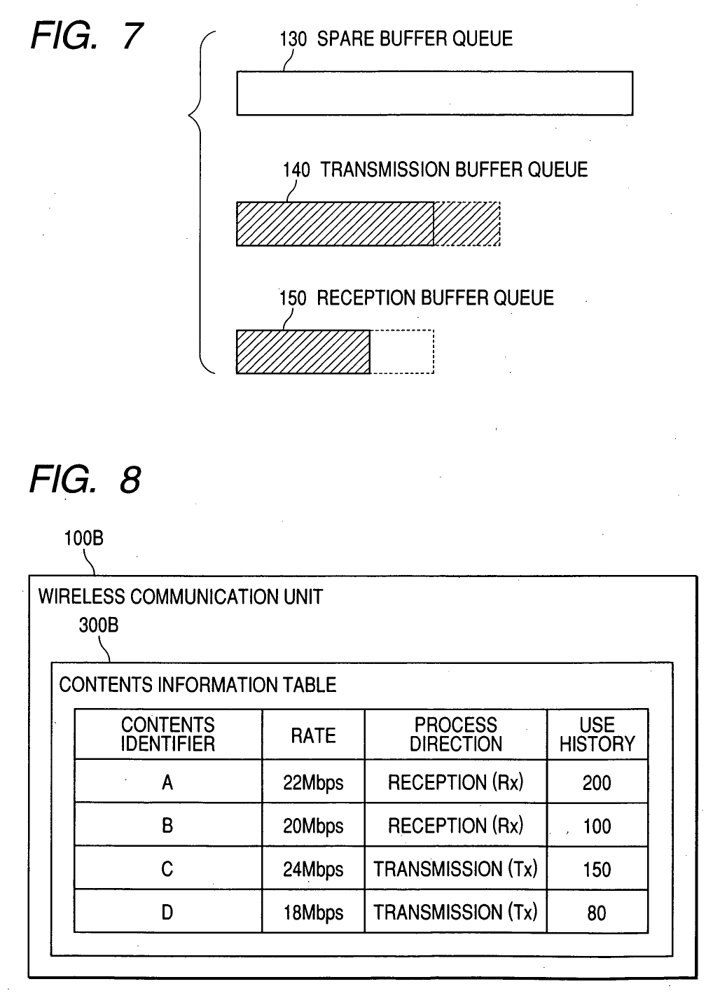

To resolve this problem, in this embodiment, as is shown in FIG. 7, different buffer queues are provided for transmission and reception, and these can be extended by obtaining a buffer, as needed, from the original buffer queue.

That is, in this embodiment, the buffer queue 410 of the wireless communication unit 100B is separated to form a spare buffer queue 130, a transmission buffer queue 140 and a reception buffer queue 150.

The wireless communication unit 100B allocates only the size required for a buffer for the transmission buffer queue 140 and the reception buffer queue 150. When, as a result of the rearrangement, a larger buffer size must be allocated for the transmission buffer queue 140 or the reception buffer queue 150, the required buffer space is obtained from the spare buffer queue 130.

When as a result of the rearrangement the size of the transmission buffer queue 140 or of the reception buffer queue 150 can be reduced, the excess buffer space is allocated for the spare buffer queue 130. Through this processing, the reception process is not adversely affected when the transmission buffer is to be rearranged.

Using this method, when a transmission buffer queue 140 and a reception buffer queue 150 are prepared for each connected terminal, and there are a plurality of queues, the rearrangement of the buffers for one target queue can be performed without adversely affecting the transmission and reception processes for the other queues.

In this embodiment, the average rates are stored in the contents information table 300B. However, the size of a buffer to be allocated may be stored, for example, as the recommended size for a buffer.

### Second Embodiment

The contents are not always transmitted or received at a specific, constant rate. The rate at which the contents are stored in the contents information table 300B in FIG. 4 is the average rate for the contents, and were the rate to be locally increased, this would cause a buffer overflow.

Therefore, as is shown in FIG. 8, an entry for use history is added to the contents information table 300B. The use history then corresponds to the maximum sizes of buffers actually used, in the past, for transmission and reception. Since, however, the buffer use history information for the individual contents is retained, the maximum sizes of buffers actually used in the past can be obtained. In this embodiment, basically, instead of the sizes of buffers being calculated based on the average rate, buffers having sizes based on the use history are allocated for the transmission buffer 420 and the reception buffer 430.

However, when the total size of a buffer nears the limit, the size of a buffer to be allocated is reduced by referring to the size of the buffer when correlated with the average rate. That is, when the size of an allocated buffer, based on the average rate, differs greatly from the maximum size of the buffer, consonant with the use history, it is highly probable that a buffer for which the size is greater than necessary is to be allocated, and the size of the buffer that is to be allocated can be reduced.

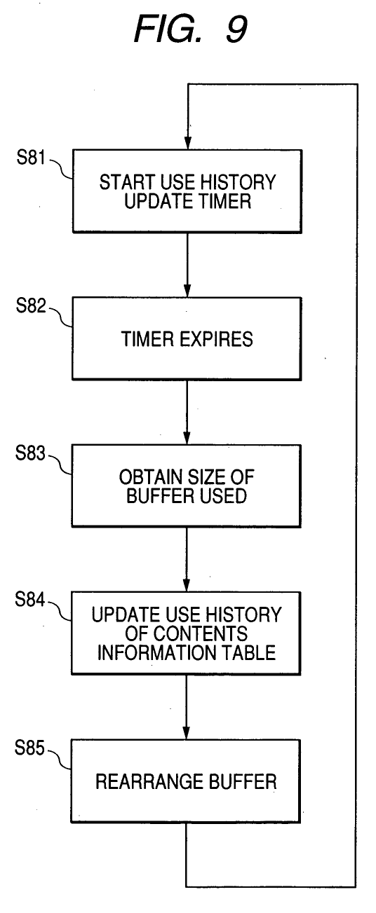

FIG. 9 is a flowchart that shows the processing performed to add the use history information to the contents information table 300B. To add the use history information to the contents information table 300B, first, a history information updating timer is activated (step S81). Then, when the period allocated for the timer has expired, following the elapse of a specific time period (step S82), the size of the buffer currently being used is calculated by referring to the transmission (or reception) buffer queue (step S83).

Then, the value of the history of the current contents is obtained from the contents information table 300B. And when the value given for the size of the currently used buffer exceeds the history value, the value given for the size of the currently used buffer is entered, as a new history value, in the contents information table 300B (step S84), and the buffer is rearranged (step S85). Then, the history information updating timer is again activated (step S81). When this process is repeated each time a predetermined time has elapsed, a buffer allocation can be performed that more nearly approaches the optimal.

### Third Embodiment

For wireless data communication, the error state may constantly be changed due to the installation location or the interference provided by an obstacle or another wireless device. Because of this, the optimal distribution of the transmission buffer 420 and the reception buffer 430 may not be obtainable even when these buffers are appropriately distributed in accordance with the communication rate.

To cope with this case, at a specific interval, a transmission terminal collects statistics on for the frequency of transmissions and the frequency of errors, calculates the error rate based on the obtained statistic data, and changes the size of the buffer in accordance with the error rate. In this manner, the optimal size of the buffer can always be distributed.

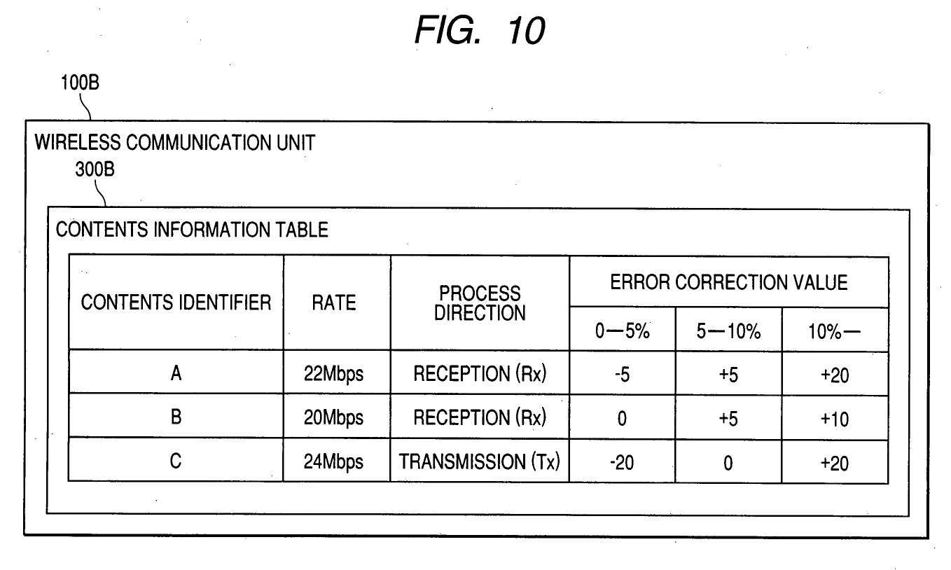

In FIG. 10, the required size of the buffer for each error rate is additionally entered as an error correction value to the contents information table 300B. In this embodiment, the size of the buffer is rearranged, so that the size of the buffer obtained by adding the error correction value to the size of the buffer based on the average rate is allocated. That is, the value obtained by adding the size of the buffer corresponding to the error correction value to the size of the buffer obtained based on the average rate, or by subtracting the error correction value from the size of the buffer is allocated to the transmission buffer 420 and the reception buffer 430.

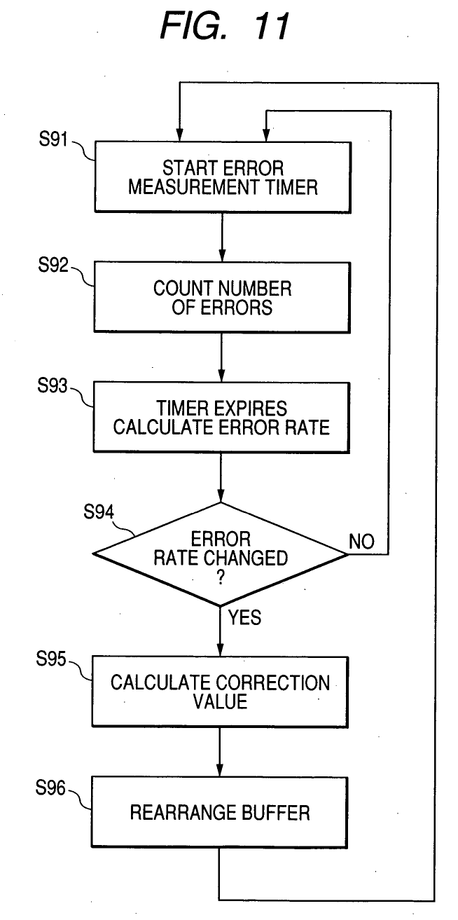

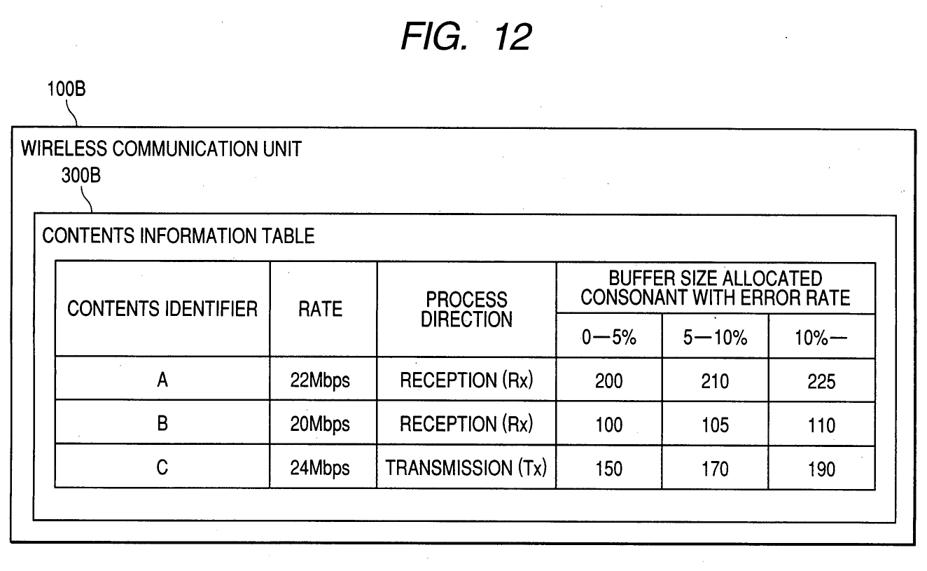

FIG. 11 is a flowchart showing the processing for rearranging the size of the buffer due to a change in the error rate. In order to measure the error rate, first, an error measurement timer is activated (step S91). While the timer is being operated, the number of errors and the frequency of transmissions are measured (step S92). When the time for the error measurement timer has expired, the error rate is calculated by using the frequency of transmissions and the number of errors (step S93).

For example, when the wireless communication apparatus 100B including the contents information table 300B in FIG. 10 is performing the transmission process for the contents A, and when the previously obtained error rate is 3% and the currently obtained error rate is 6%, it is found that the size of the corrected buffer for the contents A, which is consonant with the error correction value in the contents information table 300B, has been changed from −5 to +5 (Yes at step S94). Therefore, it is understood that the size of the buffer should be increased by +10 (step S95), and the transmission buffer 420 and the reception buffer 430 are rearranged (step S96).

When the error rate is unchanged (No at step S94), the error measurement timer is started and the processing is terminated. When this processing is repeated, the optimal buffer arrangement is always enabled in accordance with the change for the error rate.

Instead of holding, in the table, the size of the buffer that is the error correction value, the allocated size of the buffer consonant with the error rate may be held in the table. Both cases are essentially the same.

### Fourth Embodiment

Data transfer can not be performed when an effective rate for the wireless communication is exceeded, i.e., the data transfer fails when the total value for the rates used for the transmission and the reception exceeds a specific value. Therefore, in the contents information table 300B shown in FIG. 4, the transmission buffer 420 and the reception buffer 430 are allocated for contents in the order of their arrival, and allocation in accordance with priority can not be performed.

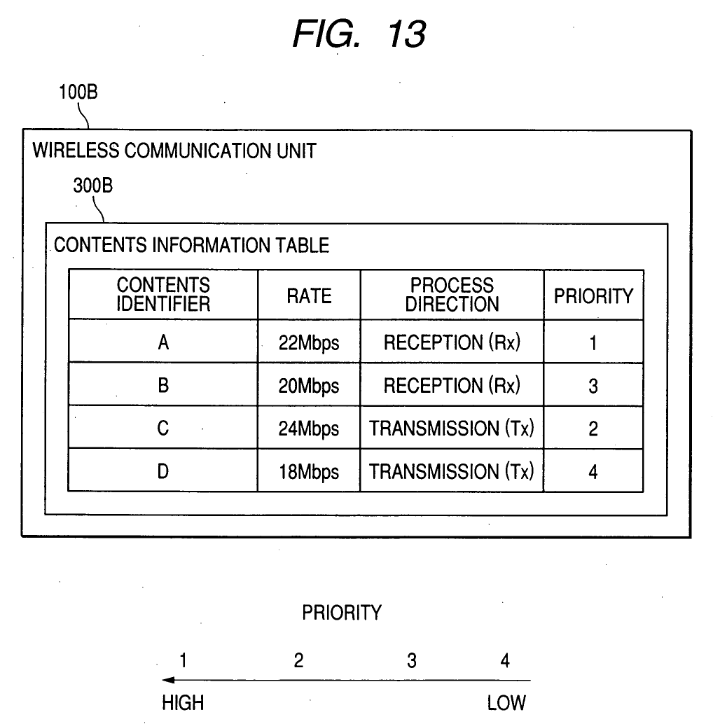

To avoid this problem, as is shown in FIG. 13, the contents information table 300B is extended to hold priority information. That is, the buffer is more preferentially allocated for contents, such as recording contents, having a higher priority than for contents having a lower priority.

For example, in the contents information table 300B in FIG. 13, the buffer is preferentially allocated for the contents A, which have the highest priority. On the other hand, a size adequate for the buffer may not be allocated for the contents D having the lowest priority. It should be noted, however, that since a buffer size large enough for the transmission and reception of the contents is always obtained for the contents A having the higher priority, data transmission having a stable quality can be performed.

### Fifth Embodiment

A function is additionally provided whereby, when a new contents type is added, the size of the contents information table 300B in FIG. 4 is extended by adding an information table. With this function, when the contents types selectable by a user are increased, or when a contents processor 100A, such as an AV apparatus, is additionally connected to the wireless communication unit 100B that serves as a source, or is changed, either case can be easily coped with.

Further, a function is also provided for enabling the broadcast subject of the contents type that has been registered in advance. With this function, a case wherein the rate is changed, in accordance with the broadcast subject of the contents type that has been registered, can easily be coped with.

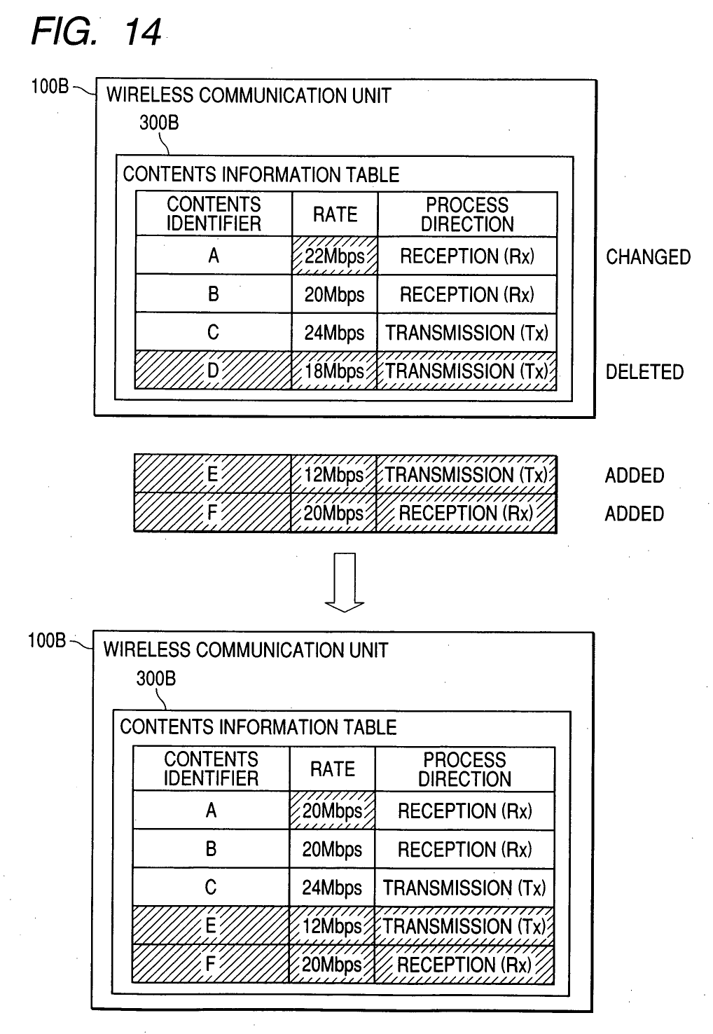

These functions will be explained while referring to FIG. 14. Assume that four types of contents information (A, B, C and D) are registered in advance in the contents information table 300B, and that a request for changing the rate for the contents A is issued to the wireless communication unit 100B to change the rate to 20 Mbps.

The wireless communication unit 100B reads the change rate of 20 Mbps from the rate change request, and updates, to 20 Mbps, the rate information for the contents A stored in the contents information table 300B.

Further, when a contents deletion request is issued to the wireless communication unit 100B, e.g., when the information for the contents D is registered in the contents information table 300B, and the request for the deletion of the contents D is issued to the wireless communication unit 100B, the wireless communication unit 100B deletes the information for the contents D from the contents information table 300B.

An explanation will now be given for a case wherein additional contents information is to be entered, e.g., a request for adding contents information (E, F) in FIG. 14 is issued to the wireless communication unit 100B, i.e., a case wherein the addition process is to be performed after the change process and the deletion process have been performed.

The contents E and the contents F are information to be newly added. The information for the contents is stored in the area where the contents D were stored, and the information for the contents F is stored by extending the contents information table B.

As a result, when the contents types selectable by a user are increased, or when a contents processor 100A, such as an AV apparatus, is additionally connected to the wireless communication apparatus 100B, which is a source, or is changed, either case can easily be coped with.

According to the radio module of this invention, since the transmission buffer area and the reception buffer area of the buffer queue is varied in accordance with the contents type, the size of the buffer required for the transmission process and the reception process can always be optimized, and the memory resources can be effectively utilized. This invention effectively provides, for the performance of wireless data communication, an optimal control technique for the transmission buffer and the reception buffer.

1. A radio module comprising:
a wireless communication unit, performing the wireless communication of contents; and
a contents processor, processing contents that are to be transmitted or that are received by the wireless communication unit,
wherein the wireless communication unit includes
a buffer queue, including a variable buffer structure having:
a transmission buffer area, for temporarily holding the contents to be transmitted; and
a reception buffer area, for temporarily holding the received contents; and
wherein, in accordance with the type of contents processed by the contents processor, the transmission buffer area and the reception buffer area for the buffer queue are changed.

2. The radio module according to claim 1,
wherein the wireless communication unit further includes:
a contents information table in which information concerning the size of a buffer required for a process, and information indicating the type of process, either a transmission process or a reception process, are to be stored in correlation with the contents type, and
wherein the contents type to be processed is changed to a different type, the contents processor transmits to the wireless communication unit information concerning the different contents type, and the wireless communication unit examines the contents information table to change the transmission buffer area and the reception buffer area for the buffer queue.

3. The radio module according to claim 2, wherein information concerning the size of a buffer required for a process includes an average rate required for the transmission/reception of the contents, and in accordance with the average rate, the wireless communication unit changes the transmission buffer area and the reception buffer area for the buffer queue.

4. The radio module according to claim 2, wherein information concerning the size of a buffer required for a process includes a recommended buffer size to be allocated for the contents, and in accordance with the recommended sizes of buffers, the wireless communication unit changes the transmission buffer area and the reception buffer area for the buffer queue.

5. The radio module according to claim 2, wherein the buffer queue includes:
a transmission buffer queue, used for transmission;
a reception buffer queue, used for reception; and
a spare buffer queue, from which the size of a buffer can be allocated for the transmission buffer queue and the reception buffer queue.

6. The radio module according to claim 2, wherein information concerning the size of a buffer required for a process includes a use history, for the size of a buffer used for the contents in the past, and in accordance with the use history, the wireless communication unit changes the transmission buffer area and the reception buffer area for the buffer queue.

7. The radio module according to claim 6, wherein the use history is the maximum value for the size of a buffer used for the contents in the past.

8. The radio module according to claim 2, wherein information concerning the size of a buffer required for a process includes an error rate for each contents type and a corrected size for a buffer corresponding to the error rate; and wherein the wireless communication unit calculates the error rate during the transmission and reception of the contents, and in accordance with a corrected size for a buffer, changes the transmission buffer area and the reception buffer area for the buffer queue.

9. The radio module according to claim 2, wherein information concerning the size of a buffer required for a process includes an error rate for each contents type and a recommended size for a buffer corresponding to the error rate; and wherein the wireless communication unit calculates the error rate during the transmission and reception of the contents, and in accordance with the recommended size for a buffer, changes the transmission buffer area and the reception buffer area for the buffer queue.

10. The radio module according to claim 2, wherein information concerning the size of a buffer required for a process includes priority information for each contents type, and in accordance with the priority information, the wireless communication unit changes the transmission buffer area and the reception buffer area for the buffer queue.

11. The radio module according to claim 2, wherein the wireless communication unit has a function for updating, adding or deleting information stored in the contents information table.
